(19) United States
(12) Patent Application Publication
(10) Pub. No.: US 2002/0099637 A1
(43) Pub. Date: Jul. 25, 2002

(54) Intellectual property investment process

(76) Inventors: William T. Wilkinson, Salem, NJ (US); David E. Martin, Charlottesville, VA (US)

Correspondence Address: Ratner & Prestia, P. O. Box 7228, Wilmington, DE, 19803, US

(21) Appl. No.: 09/915,685

(22) Filed: Jul. 26, 2001

Related U.S. Application Data
(60) Provisional application No. 60/220,873, filed on Jul. 26, 2000.

(51) Int. Cl. G06F 17/60

(52) U.S. Cl. 705/36

(57) ABSTRACT

A process for investment in intellectual property, comprising providing an accounting for an intellectual property investment; providing a valuation with respect to the intellectual property investment; performing financial analysis related to the intellectual property investment and making a recommendation based upon the financial analysis; and managing the investment based upon the accounting, valuation, and analysis for the investment. The financial analysis includes computing one or more financial ratios or indices, comparing financial information relating to the IP investments to one or more other IP investments, and making a financial transaction recommendation with respect to the IP investment. The analysis and recommendation process may stand alone or may be used in conjunction with pre-existing, non-IP-based securities analysis and recommendation/estimation processes.

### CROSS-REFERENCE TO RELATED APPLICATIONS

This application claims priority of U.S. Provisional Application Serial No. 60/220,873, filed on Jul. 26, 2000, incorporated herein by reference.

### TECHNICAL FIELD

This invention relates to intellectual property (IP), and more particularly to the management of investment in intellectual property assets.

### BACKGROUND OF THE INVENTION

In the past, intellectual property assets (including but not limited to patents, trade secrets, know-how, copyrights, software, trademarks, domain names, licenses and the like) have been considered to have little or no value as assets, and have been classified as “intangibles” on the balance sheet. Related assets, such as products and technologies based in large part upon such intellectual property, have also frequently been assigned little or no concrete value.

The co-inventors' previous work has been dedicated to developing a dependable and accurate valuation method and process for intellectual property and related assets. The co-inventors believe their work provides a reliable valuation system for intellectual property and related assets that allows for more accurate tangible values to replace the intangible/negligible asset values currently used. In particular, co-inventor Will Wilkinson's work includes an intellectual property audit method disclosed by U.S. Provisional Patent Application Serial No. 60/240,135, filed on Oct. 13, 2000; a method for intellectual property securitization and creating intellectual property financial markets described in U.S. patent application Ser. No. 09/797,930, filed Mar. 2, 2001 and based upon a provisional application filed Mar. 2, 2000; a method for providing intellectual property insurance described in U.S. Provisional Application Serial Number 60/242,307, filed Oct. 20, 2000; and a method for assigning tangible value to IP assets described in U.S. application Ser. No. 09/593,576, filed Jun. 14, 2000, based upon an earlier filed provisional application; all of which are incorporated herein by reference.

Co-inventor David Martin's work includes formation of M-CAM Inc., of Charlottesville, Va., of which he is the CEO, which offers a number of intellectual property search, brokerage, reporting and valuation services described in more detail herein and in M-CAM's Internet website, accessible at www.m-cam.com, the contents of which are incorporated herein by reference.

In addition, where the intellectual property and related assets constitute a material part of the assets and income of a controlling entity (including but not limited to corporations, partnerships, mutual funds, portfolios, individual sole proprietorships, and the like) that owns or controls it, the valuation system, financial markets, and investment process can be used to revalue the entire controlling entity.

With the adoption of tangible values for intellectual property and related assets, the opportunity to securitize intellectual property and create financial markets for intellectual property arises. The securitization of intellectual property and the creation of dependable and accurate financial markets for intellectual property assets is the subject of the '930 application noted above.

Recently, there have been attempts, most notably on the Internet, to create auction sites for patents/inventions, and other intellectual property. These sites do not provide a sophisticated, underlying analytical valuation system that can generate the consistent, dependable values needed for reliable financial markets.

With the advent of tangible values for intellectual property, the securitization of intellectual property, and the creation of financial markets for intellectual property, the need arises for a reliable system and process for investing in intellectual property/related assets and entities that own, control, or create the IP (corporations, partnerships individuals, funds, etc.). Intellectual property is an asset with unique characteristics that differentiate it from other types of investment assets. It therefore follows that intellectual property requires a unique investment process that takes into account factors unique to IP to achieve desired investment objectives. Such an investment process and system is the subject invention of this application.

### SUMMARY OF THE INVENTION

The invention comprises a process for investing in intellectual property comprises providing an accounting for an intellectual property investment; providing a valuation corresponding to the intellectual property investment; performing financial analysis related to the intellectual property investment; and managing the investment based upon the accounting, valuation, and analysis for that investment. Management of the investment may comprise determining one or more investment objectives/strategies, conducting one or more financial transactions concerning the investment, and monitoring/tracking performance of the investment. The financial analysis includes computing one or more financial ratios or indices, comparing financial information relating to the IP investments to one or more other IP investments, and making a financial transaction recommendation with respect to the IP investment. The process of this invention may be applied throughout the entire life cycle of the IP investment. The analysis and recommendation process may stand alone or may be used in conjunction with a pre-existing, non-IP-based analysis, earnings-per-share estimation, and recommendation processes. The intellectual property investments may comprise one or more intellectual property assets and/or related assets, or one or more entities with control of or responsible for the creation of one or more intellectual property assets.

The step of calculating the total net intellectual property asset value may comprise, for each intellectual property asset related to the intellectual property investment, one or more of: determining the cost or book value of the intellectual property asset; computing a basic liquidation or collateral value of the intellectual property asset; computing an estimated intellectual property asset fair market value; and computing an intellectual property asset fair market value by transactions in a financial market. These values are totaled for each intellectual property asset and the totals for each intellectual property asset relating to an intellectual property investment are summed to determine the total net intellectual property asset value of the intellectual property investment.

One or more periodic investment performance reports reporting a rate of return and risk related to one or more of the intellectual property investments may be issued. The accuracy of the investment performance reports may be verified through independent, third party validation.

The process of this invention may be used by an entity internally to manage intellectual property investments controlled by that entity, or may be used externally to manage intellectual property investments not controlled by that entity.

In one embodiment, the process for investment in intellectual property comprises the steps of identifying one or more intellectual property investments; identifying relevant valuation and risk factors for each intellectual property investment; calculating a total net intellectual property asset value for each intellectual property investment; and managing, selecting, or recommending one or more intellectual property investments based upon the total net intellectual property asset value and the risk factors.

The invention extends to any method comprising making a recommendation based upon financial analysis for the investment, and may further comprise performing the financial analysis based upon an accounting and a valuation for the investment, as well as performing the valuation.

### BRIEF DESCRIPTION OF DRAWING

FIG. 1 is a partial flowchart of an exemplary process according to the invention;

FIG. 2 is a continuation of the flowchart of FIG. 1.

### DETAILED DESCRIPTION OF INVENTION

The intellectual property investment process of this invention has at least two distinct applications. A first application is for financial managers, and the investing public, to invest in a broad range of intellectual property assets, usually owned by more than one entity. The general purpose is to maximize the returns to investors, according to one or more financial objectives. The investments may comprise intellectual property/related assets, and/or the entities that own, control, or create these assets. A second application is for the management of a given entity to optimize the return on its intellectual property assets, for example the intellectual property that it has primarily developed through internal research and development and/or through acquisitions/licenses relating to specific products and technologies.

The method of this invention provides two mechanisms to realize investment opportunities. Both mechanisms involve identifying, valuing, and selecting investments based upon the potential for appreciation or depreciation of the investment due to the value or change in value of one or more intellectual property assets, related assets, or controlling entities. In a first mechanism, the change in value is from an intangible value to a tangible value. In the second mechanism, the change is from a first tangible value to a second tangible value. Thus, for example, where one or more analysts may have prepared financial recommendations for a security for an entity, for example, based upon a number of factors, but not including intellectual property among the tangible assets of the entity, the application of the process of this invention to take into account intellectual property controlled by the asset changes the intangible value of the intellectual property to a tangible values. After the intellectual has already been considered to have some tangible value, any future application of the process may change the value to a different tangible value.

The method of this invention can involve any type of financial transaction, such as buying, licensing, hypothecating, optioning, selling, donating, and the like. In a preferred case, the method is applied to financial transactions related to the value of intellectual property over its life cycle. The life cycle of intellectual property values may include, but are not limited to, any or all of the following stages, in no particular order, some of which may occur simultaneously:

1. Conception/Reduction to practice

2. Disclosure

3. IP protection filed (i.e. patent, copyright, or trademark application)

4. IP protection issued

5. IP Licensing

6. Market-ready product

7. Marketed product

8. Discontinued product

9. Expired IP protection

10. Bank loan (IP as collateral)

11. Private placement

12. Venture capital

13. New issue/Initial Public Offering (IPO)

14. Secondary issue

15. Portfolio, fund/mutual fund management

16. Merger/acquisition

17. Spinoff

18. Leveraged buyout

19. Insurance

20. Donation

21. Tax valuation

22. Bankruptcy

An exemplary intellectual property investment process of this invention may include one or all of the following steps:

1. Define Investment Objectives;

2. Define Investment Strategy;

3. Identify the intellectual property asset, related asset, or owner/control entity;

4. Classify the asset/entity;

5. Identify the relevant valuation and risk factors per asset;

6. Analyze and compute the basic liquidation/collateral value of the asset;

7. Analyze and determine the estimated asset fair market value;

8. Determine the asset fair market value by transactions in the financial market;

9. Total the individual asset values that relate to a particular investment, to determine a total net asset value;

10. Rank and compare investments based on their total net IP asset value, and risk;

11. Select investments based upon the expected value/price change due to total net IP values and risk;

12. Generate periodic investment performance reports to monitor/track the rate of return and risk from intellectual property investments;

13. Confirm the accuracy of investment performance reports, through independent, third party validation;

Thc process of this invention is applicable to investment in any type of intellectual property/related assets. The term “related assets” refers to assets that are based upon the intellectual property asset, such as a specific products, licenses, or technologies. As used herein the term “intellectual property/related assets” means the intellectual property itself and/or the related assets. In most circumstances, when the process is applied to an individual intellectual property asset, the related assets will be considered along with the intellectual property asset, but the process may also be applied to the intellectual property alone, without taking into account the related assets, if any. The method is also applicable to investment in any type of entity (corporation, partnership, individual, sole proprietorship, fund, portfolio, etc.) that owns, controls, or creates the property/asset.

One unique application is the valuation and securitization of one or more creative individuals, such as inventors. Thus, a creative person, or persons, may be turned into a security for the purposes of investment analysis, investment, or employment, and the process of this invention may be used to, for example, track the performance of an individual creative person. These creative people, or “creators” may include but are not limited to authors, artists, inventors, programmers, songwriters, musicians, and the like.

Intellectual Property/related assets, and owner/controlling/creative entities can include, but are not limited to:

| | | | |
|---|---|---|---|
| 1. | Patents | 14. | Corporate divisions |
| 2. | Trade secrets | 15. | Corporations |
| 3. | Know-how | 16. | Partnerships |
| 4. | Trademarks | 17. | Funds, mutual funds |
| 5. | Service marks | 18. | Stocks |
| 6. | Logos | 19. | Bonds |
| 7. | Domain names | 20. | Asset based loans/securities |
| 8. | Copyrights | 21. | Primary offerings/IPO's |
| 9. | Licenses | 22. | Secondary offerings |
| 10. | Products | 23. | Futures |
| 11. | Technologies | 24. | Derivatives |
| 12. | R&D projects | 25. | Options, warrants |
| 13. | Software | 26. | Bankruptcies |
| | | 27. | Creators |

The intellectual property investment process of this invention is applicable to the use of any kind of intellectual property valuation method including, but not limited to valuation methods based upon one or more of the following factors:

1. Type of intellectual property asset

2. Type of related intellectual property asset

3. Type of owner/controller entity

4. Purpose of intellectual property

5. Time-remaining life

6. Validity/Legality

7. Invalidation risk

8. Misjoinder

9. Status (i.e. pending, issued)

10. Payment of maintenance fees

11. Claim strength, breadth of coverage

12. Infringement

13. Competition, substitutes

14. Risk of circumvention

15. Dominant related patents

16. Litigation

17. Liens

18. Royalty income (past, present, future)

19. Licensing income

20. Assets controlled by IP (molds, tools, inventory, factories)

21. Search integrity/quality

22. Examination quality

23. Time to commercialize/market

24. Expense to commercialize/market

25. Market life

26. Brand strength

27. License life

28. License exclusivity

29. License viability, legality

30. Cost/expense of IP asset

The intellectual property valuation methods can be used to determine any type of intellectual property value relating to a particular asset, including but not limited to:

1. Cost

2. Book value

3. Collateral/loan/liquidation value

4. Estimated fair market value

5. Fair market value

6. Bid/Offer value

7. Public offering value (initial/secondary)

8. Donation value

9. Taxation value

10. Bankruptcy value

11. Option or derivative value

A preferred method of this invention involves one or more of at least four basic valuation steps:

1. Determining a collateral/loan/liquidation value

2. Determining an estimated fair market value by analysis of relevant valuation factors.

3. Determining a fair market value by an open market auction.

4. Determining a distressed asset valuation through bankruptcy, a sealed bid auction, an open market auction, or a fair market evaluation.

The method of this invention may use 1) any kind of analytical tool or technique to evaluate investments, and 2) any kind of investment management or selection technique to optimize the return and achieve investment objectives.

To assist in the analysis of IP assets and related assets as investments, a group of unique mathematical ratios and formulas may be used, including but not limited to ratios that indicate value and risk, such as:

$$\frac{\text{Total IP Value}}{\text{(Net Worth or Book Value)}}$$

$$\frac{\text{Total IP Value}}{\text{Total Assets}}$$

$$\frac{\text{Total IP Value}}{\text{Total Revenues}}$$

$$\frac{\text{Total IP Value}}{\text{Total Net Income}}$$

$$\frac{\text{Total IP Value}}{\text{Share (or unit)}}$$

Total IP Value per Share (or unit) as a percentage of Earnings per Share (or unit)

Total IP Value as a percentage of Total Market Capitalization

Total IP Value per Share (or unit) as a percentage of Share (or unit) Book Value or Fair Market Value

Other analytical tools include ranking, indexing, and risk analysis.

### Ranking

In accordance with the method of this invention, each intellectual property asset and related asset may be identified, valued, and traced to its corresponding owner entity. Thus, for example, each stock on each stock exchange in the world may have its intellectual property assets identified and valued, so that the impact of intellectual property values and changes may be analyzed for investment purposes. Securities, such as but not limited to equity or debt (such as stocks or bonds, respectively), may then be ranked and compared based on their potential to appreciate or depreciate based upon the related intellectual property holdings or exposure. The intellectual property assets related to a particular security or entity may be tracked on a regular basis to make periodic adjustments and to maintain accurate estimates of the impact of changing intellectual property values on the value of a security or entity.

Entities or related securities may then be ranked by the number of intellectual property assets controlled or owned and/or the total intellectual property value per entity. Intellectual property assets may be ranked by the value of the individual intellectual property assets and/or related assets. Securities may be ranked based upon the intellectual property value per unit.

### Indexing

The method may also include various comparative indices to help compare and rank the relative value, risk, and performance of individual intellectual property assets, related assets, classes of intellectual property assets, securities and stocks impacted by intellectual property assets, and controlling entities impacted by intellectual property assets. A key value index may comprise a representative sample designed to track the general market price performance of intellectual property assets (analogous to the S&P 500), or track the performance of a particular intellectual property industry or segment, such as technology, small capitalization entities, large capitalization entities, or the like.

### Risk Analysis

The method may also include a method to assess the risk inherent in the intellectual property assets, related assets, and/or controlling entities, by analyzing factors that may impact their value. Some of the risks inherent in intellectual property include: risk of invalidation or determination of unenforceability, risk of circumvention, risk of technology becoming obsolete, risk of litigation, risk of infringement, risk of non-ownership, risk of expiration or abandonment, and the like. Evaluation of these risk factors may be performed by any risk analysis technique known in the art. The risk can be expressed in part by the probability of changes in value due to intellectual property factors. The method may further include creation of a risk scale for intellectual property assets, related assets, and/or controlling entities, to rank the degree of risk or volatility from high to low. A group of comparative risk indices may be used to compare the relative risk of individual intellectual property assets, classes of intellectual property assets, securities or stocks impacted by intellectual property assets, or entities impacted by intellectual property assets. IP assets, related assets, securities, and entities can then be ranked, according to their potential risk for appreciation or depreciation. Insurance hedge strategies may be used to manage IP risk.

### Other Investment Techniques

The method of this invention may employ additional techniques as part of the investment process such as:

Unitizing or dividing intellectual property assets into units or shares, to allow for joint/fractional ownership of an individual intellectual property asset or group of assets.

Computing the intellectual property unit or share value of a given intellectual property asset by dividing the total value of the intellectual property asset by the number of units or shares.

Creating and issuing certificates of ownership denoting ownership of one or more intellectual property shares or units.

Creating a mutual or common fund composed of individual intellectual property assets, such as patents, trademarks, and the like.

Creating a fund composed of individual intellectual property related assets, such as products, technologies, and the like.

Creating funds composed of the securities of entities that own or control intellectual property assets.

Creating a fund based on a combination of individual intellectual property assets, related intellectual property assets, and intellectual property controlling entities.

Creating an intellectual property fund based upon investment objectives, such as income, growth, balanced, etc.

Computing an intellectual property fund unit value by dividing the total value of all intellectual property assets in the fund by the number of units.

Investing in intellectual property assets using borrowed funds to leverage returns.

Using of an intellectual property performance measurement system to compute the rate of return and associated risk of a particular intellectual property investment.

Using an independent third party to audit and confirm the accuracy and fairly stated values for intellectual property risk and return investment performance calculations.

Investing in intellectual property assets based on their degree of risk (high, medium, low).

Investing in intellectual property assets based upon their location or country in which they are located, owned, etc.

Using arbitrage for intellectual property assets.

Using hedging strategies based on intellectual property assets.

Creating managed funds, pools, accounts, portfolios, and the like composed of intellectual property assets, related assets, and intellectual property entities.

Creating an intellectual property index fund to invest in or track a given intellectual property index.

Issuing security options and derivatives based upon a future value change of one or more intellectual property assets.

Investing in intellectual property assets, to reduce the amount of goodwill written off in a merger or acquisition.

Investing in intellectual property assets according to common characteristics, such as the type of intellectual property asset, type of controlling entity, type of industry, or type of related assets, such as products or technology.

Investing in insurance pools or syndicates for intellectual property.

The use of a mutual fund or partnership may be a particularly desirable intellectual property investment mechanism, because it permits diversity and helps to reduce risk. Intellectual property assets are often depreciating assets that are complex and have high risk/volatility of values.

### EXAMPLE

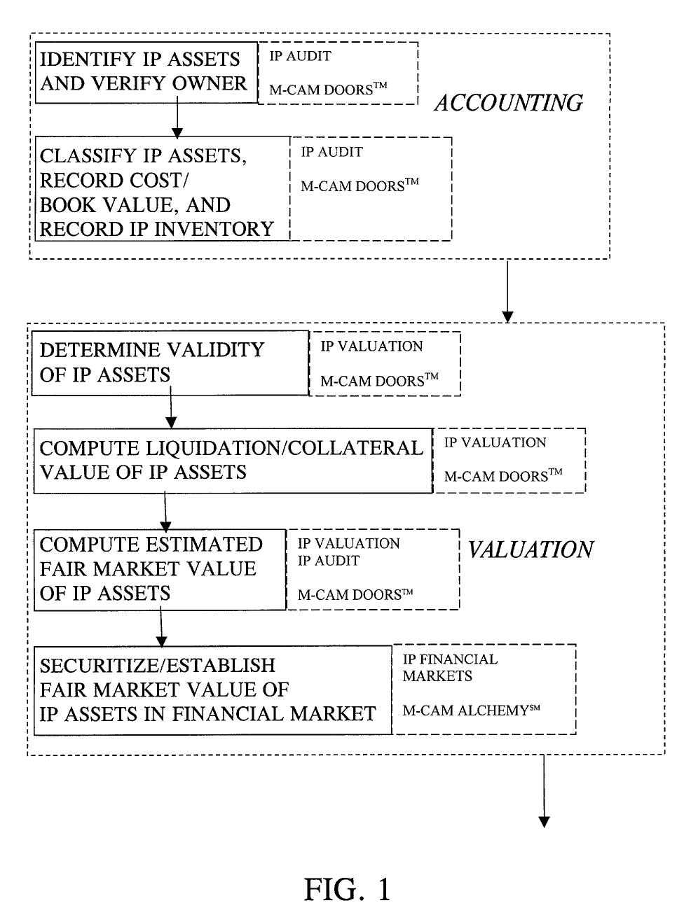

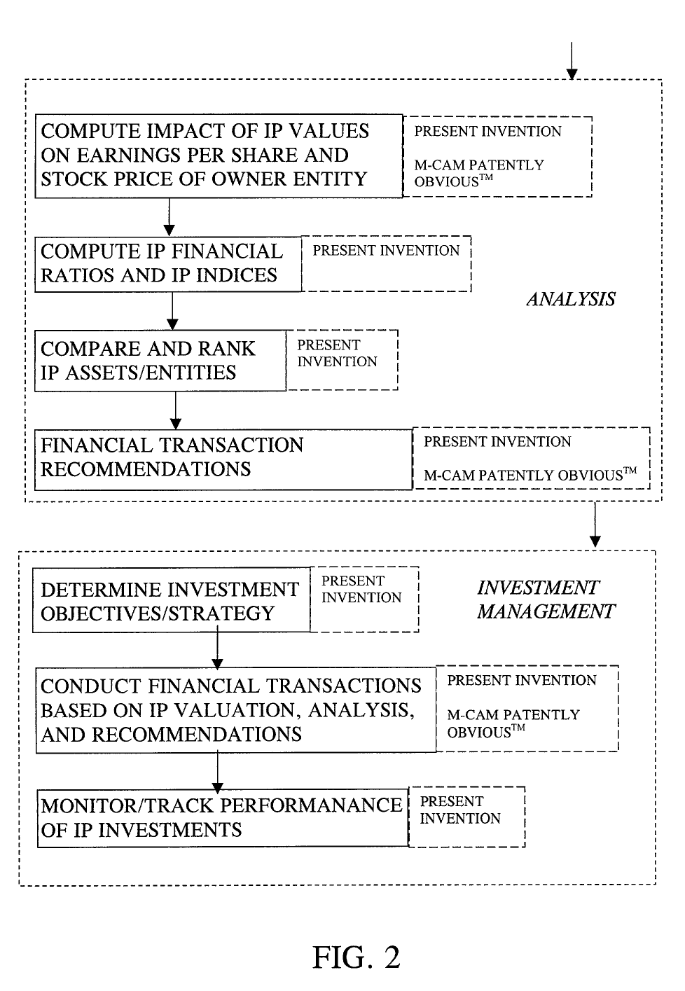

Referring now to FIGS. 1 and 2 there is shown a flowchart detailing exemplary steps in the present invention. The flowchart, beginning in FIG. 1 and continuing in FIG. 2, can be broken down into four subprocesses: an accounting subprocess, a valuation subprocess, an analysis subprocess, and an investment management subprocess. Within each subprocess are several smaller steps listed in a two-compartment box: on the left hand side (defined by solid lines) is a description of the step, and on the right hand side (defined by dashed lines) is a source identifier. The source identifier refers to the source of details for each step. The following identifiers as used in the chart have the following meanings:

| | |
|---|---|
| IP AUDIT | U.S. Provisional Patent Application |
| | Ser. No. 60/240,135 |
| IP VALUATION | U.S. application Ser. No. 09/593,576 |
| IP FINANCIAL | U.S. patent application Ser. No. 09/797,930 |
| MARKETS | |
| PRESENT | This specification, and its priority document U.S. |
| INVENTION | Provisional Application Ser. No. 60/220,873 |
| M-CAM DOORS ™ | Commercially available software product and |
| | search services provided by M-CAM Inc. |
| M-CAM CAPP ^{SM} | Capital Asset Purchase Price program developed |
| | and marketed by M-CAM, as described herein |
| | and by reference |
| M-CAM | Brokerage service offered by M-CAM for the sale |
| ALCHEMY ^{SM} | and licensing of IP |
| M-CAM | Reports issued by M-CAM based upon |
| PATENTLY | intellectual property analysis performed by |
| OBVIOUS ™ | M-CAM |

As shown in FIGS. 1 and 2, the accounting subprocess generally may include the steps of identifying intellectual property (IP) assets and verifying the owner of those assets. These steps are discussed generally in the '135 Application, and a commercial service for identifying assets and ownership is provided by M-CAM. For example, when the investment process of this invention is directed to an entity having IP assets, the M-CAM (or other supplier's) search service may be used to search various databases, such as those maintained by the US Patent & Trademark Office (USPTO) or Copyright Office, to find any IP assets for which ownership has been recorded. From this kind of search, issues relating to title to the assets may be discovered. Then, the assets can be categorized and the cost or book value for each, based upon information supplied by the controlling entity or agent of the entity, can be recorded in an inventory of all the assets for the particular entity. Where individual IP assets are the target of the process of this invention, the accounting step may be to identify the related assets that depend on that IP asset, such as technologies, commercialized products, or business divisions of one or more companies.

Next, the valuation subprocess is performed, which may include the steps of determining validity of the IP assets. Such a step may include, for example, performing a prior art search with respect to an issued patent, to determine if any references overlooked by the USPTO may anticipate or render the patent obvious, thus invalidating the patent. Computation of a liquidation/collateral value for the IP assets is available by utilizing the services of M-CAM, as described in “Smarts Money,” by Phaedra Hise, in the Jan. 1, 2000, issue of Inc. Magazine. The estimated fair market value may be computed using any of the valuation methods described in the '576 or '135 Applications. In one embodiment, the M-CAM DOORS™ program provides a search of patents subsequent to an issued patent. Such analysis may show that one or more subsequent patents is a candidate for licensing. Such analysis may be taken into account in estimating the fair market value. The securitization and establishment of the fair market value of the IP assets in the financial market is described in the '930 Application. M-CAM through its ALCHEMY^{SM} service provides a brokerage service for the sale and licensing of IP. Other entities provide similar services that may facilitate determining the fair market value of IP assets.

The process may comprise interfacing with one or more accounting entities, such as a certified public accountant or accounting firm, to perform the accounting and valuation subprocesses, or any of the subprocesses. It may be useful to compile one or more checklists listing the various steps and/or factors to take into account for performing the process of this invention and/or for auditing the process of this invention. The process may also comprise creating an accounting report for an entity, showing a balance sheet and income statement reflecting the valuation and earnings of the intellectual property assets corresponding to the entity.

Next, the analysis of IP assets as investments in accordance with this invention is practiced as described herein. The impact of IP values on earnings per share and stock price of an owner entity of IP assets, for example, may be computed and various financial ratios and indices may also be computed, as described herein. The impact may be computed and issued in a report, such as an M-CAM PATENTLY OBVIOUS™ report, or by some other method. From the analytical information so compiled, IP assets or entities holding those assets may be compared and ranked, and financial transaction recommendations, such as buy, sell, or hold, directed to those assets or entities are made. The recommendations may take the form of a report, such as an M-CAM PATENTLY OBVIOUS™ report that provides analysis of an entity or particular asset. It is envisioned that the process of this invention may stand alone or may be used to enhance traditional financial recommendations. For example, analysts reports on various entities are currently provided by numerous sources. The analysis that goes into making those recommendations can be enhanced by incorporating the process of this invention to account for the relative intellectual property position of an entity.

The steps within the analysis subprocess of this process may continue as an ongoing process after the IP asset has been identified or the IP inventory for the entity has been computed. The investment management subprocess of the process is also an ongoing process. After determining investment objectives, investors may then make financial transactions based upon the IP valuations, analysis, and recommendations. The ongoing management process of this invention continues to monitor and track the performance of the IP investment in the portfolio, including renewing steps within the analysis subprocess, or any of the steps in any of the subprocesss in the illustrated process, on a periodic basis.

The process of this invention may be implemented by any method known in the art. Preferably, however, a computer may be used, along with computer software and computerized databases, for carrying out the process steps of this invention. Thus, the invention also comprises a program storage device readable by a machine, tangibly embodying a program of instructions executable by the machine to perform method steps for investing in intellectual property, the method steps comprising: providing an accounting for an intellectual property investment, providing a valuation with respect to the intellectual property investment; performing financial analysis related to the intellectual property investment and making a recommendation based upon the financial analysis; and monitoring and tracking performance of the investment.

It should be understood that to the extent that specific examples of intellectual property assets, financial instruments, transaction mechanisms, tangible value types, valuation purposes, investment techniques, or analytical tools are described above, the method is by no means limited to these detailed examples. Those skilled in the art having the benefit of the teachings of the present invention as set forth herein above, can effect numerous modifications thereto. These modifications are to be construed as being encompassed within the scope of the present invention as set forth in the appended claims.

What is claimed:

1. A process for investment in intellectual property, the process comprising the steps of:
(a) providing an accounting for an intellectual property investment;
(b) providing a valuation with respect to the intellectual property investment;
(c) performing financial analysis related to the intellectual property investment and making a recommendation based upon the financial analysis; and
(d) managing the investment based upon the accounting, valuation, and analysis for the investment.

2. The process of claim 1 wherein the recommendation is a financial transaction recommendation selected from the group consisting of: buy, hold, and sell.

3. The process of claim 1 wherein step (c) comprises computing one or more financial ratios or indices and comparing financial information relating to the intellectual property investments to one or more other intellectual property investments.

4. The process of claim 1 comprising applying the process to one or more stages of a life cycle of the intellectual property investment.

5. The process of claim 1 comprising incorporating the process into a non-IP-based financial analysis, earnings-per-share estimation, and recommendation process.

6. The process of claim 1 wherein the intellectual property investment comprises an intellectual property asset; an intellectual property asset and one or more related assets; or one or more controlling, owning, and/or creative entities of one or more intellectual property assets.

7. The process of claim 1 wherein the accounting step comprises identifying one or more intellectual property assets and verifying ownership of each asset.

8. The process of claim 7 wherein the accounting step further comprises classifying the one or more intellectual property assets and recording a cost or book value for each asset.

9. The process of claim 8 wherein the accounting step further comprises compiling and recording an inventory of a plurality of intellectual property assets.

10. The process of claim 1 wherein the valuation step comprises determining whether one or more intellectual property assets are valid.

11. The process of claim 10 wherein the valuation step further comprises one or more of the following steps:
(c1) computing a basic liquidation or collateral value of the intellectual property asset;
(c2) computing an estimated intellectual property asset fair market value;
(c3) computing an intellectual property asset fair market value by transactions in a financial market; and
(c4) computing an intellectual property distressed asset valuation.

12. The process of claim 11 wherein computing the estimated intellectual property asset fair market value comprises identifying and taking into account a plurality of valuation and risk factors.

13. The process of claim 1 wherein the investment comprises a controlling, owning, and/or creative entity of one or more intellectual property assets and the method further comprises developing a total asset value for each intellectual property asset relating to the entity and summing the total asset values for each asset relating to the entity to determine a total net intellectual property asset value for the entity.

14. The process of claim 13 wherein the analysis step comprises computing impact of the total net intellectual property asset value on earnings per share/unit and share/unit price of a security related to the entity.

15. The process of claim 1 where the analysis step comprises one or more analytical techniques from the group consisting of: computing one or more intellectual property financial ratios or indices for the investment, comparing or ranking the intellectual property investment to one or more other investments, and analyzing risk factors relating to the investment.

16. The process of claim 15 where financial ratios comprise one or more of the group consisting of: total intellectual property value divided by net worth or book value, total assets, total revenues, total net income, or number of shares or units; total intellectual property value per share or unit as a percentage of earnings per share or unit, total market capitalization, or share or unit book value or fair market value.

17. The process of claim 15 wherein the financial index comprises a representative sample designed to track general market price performance of intellectual property assets, or designed to track performances of a particular intellectual property segment.

18. The process of claim 1 further comprising generating one or more periodic investment performance reports reporting a rate of return and risk related to one or more of the intellectual property investments.

19. The process of claim 18 further comprising confirming accuracy of the investment performance reports through independent, third party validation.

20. The process of claim 1 comprising a first entity using the method to manage intellectual property investments controlled, owned, created or a combination thereof by the first entity.

21. The process of claim 1 comprising a first entity using the method to invest in intellectual property investments not controlled, owned, or created by the first entity.

22. The process of claim 1 wherein the process comprises changing an intangible value for intellectual property to a tangible value.

23. The process of claim 1 wherein the process comprises changing a first tangible value for intellectual property to a second tangible value.

24. The process of claim 1 wherein the process comprises changing a first tangible value for intellectual property to a second tangible value.

25. The process of claim 1 further comprising conducting one or more financial transactions based upon the valuation, analysis, and recommendation steps.

26. The process of claim 6 wherein the creative entity is an individual.

27. The process of claim 26 further comprising tracking performance of one or more creative individuals.

28. The process of claim 26 further comprising ranking one or more entities by type of intellectual property controlled, owned, or created; number of intellectual property assets controlled, owned, or created; or value of intellectual property assets controlled, owned, or created.

29. The process of claim 1 further comprising:
determining for an entity or a security related to the entity, one or more of: estimated security price, estimated change in security price, projected earnings, or projected change in earnings, and
recommending buying, holding, or selling the security based upon the estimate or projection.

30. The process of claim 1 further comprising interfacing with one or more accounting entities for performing the accounting and valuation steps.

31. The process of claim 1 further comprising creating an accounting report for an entity showing a balance sheet and income statement reflecting the valuation and earnings of the intellectual property assets corresponding to the entity.

32. The process of claim 1 wherein the management step comprises determining one or more investment objectives/strategies, conducting one or more financial transactions concerning the investment, and monitoring/tracking performance of the investment.

33. A program storage device readable by a machine, tangibly embodying a program of instructions executable by the machine to perform method steps for investing in intellectual property, the method steps comprising:
(a) providing an accounting for an intellectual property investment;
(b) providing a valuation with respect to the intellectual property investment;
(c) performing financial analysis related to the intellectual property investment and making a recommendation based upon the financial analysis; and
(d) managing the investment based upon the accounting, valuation, and analysis for the investment.

34. A method for investment in intellectual property, the method comprising the steps of:
(a) identifying one or more intellectual property investments;
(b) identifying relevant valuation and risk factors for each intellectual property investment;
(c) calculating a total net intellectual property asset value for each intellectual property investment; and
(d) managing, selecting or recommending one or more intellectual property investments based upon the total net intellectual property asset value and the risk factors.

35. The method of claim 34 comprising comparing a plurality of intellectual property investments to one another based upon the corresponding total net intellectual property asset value and the risk factors for each.

36. The method of claim 34 wherein the intellectual property investment comprises an intellectual property asset; an intellectual property asset and one or more related assets; or one or more controlling, owning, and/or creative entities of one or more intellectual property assets.

37. A method for investment in intellectual property comprising making a recommendation based upon financial analysis related to an intellectual property investment.

38. The method of claim 37 further comprising, prior to making the recommendation, performing the financial analysis based upon an accounting and a valuation for the investment.

39. The method of claim 38 further comprising, prior to performing the financial analysis, performing a valuation for the investment based upon the accounting for the investment.

40. The method of claim 11 further comprising making an investment decision based upon the distressed asset valuation.
